(19) United States
(12) Patent Application Publication
(10) Pub. No.: US 2005/0199133 A1
(43) Pub. Date: Sep. 15, 2005

(54) Composite material bakeware

(76) Inventors: Dipak Narula, Louisville, KY (US); Vinod Narula, Louisville, KY (US)

Correspondence Address: Joan L. Simunic, 4719 Grand Dell Drive, Crestwood, KY, 40014, US

(21) Appl. No.: 11/079,025

(22) Filed: Mar. 14, 2005

Related U.S. Application Data
(60) Provisional application No. 60/553,353, filed on Mar. 15, 2004.

(51) Int. Cl. A47J 37/10

(52) U.S. Cl. 99/426

(57) ABSTRACT

The present invention is composite material bakeware having a non-stick surface and which is stable at temperatures up to about 450° F. The bakeware is scratch resistant, when used for baking it delivers essentially the same level of browning as metal or ceramic materials, and it is recyclable.

### CROSS-REFERENCE TO PRIOR APPLICATIONS

The present application claims priority to U.S. provisional patent application 60/553,353 filed Mar. 15, 2004 which is incorporated herein by reference.

### BACKGROUND

The present invention is bakeware having a non-stick surface formed from a composite material. The bakeware is stable at temperatures up to about 450° F., it is scratch resistant, when used for baking it delivers essentially the same level of browning as metal or ceramic materials, and it is recyclable.

The advent of non-stick coatings added to bakeware reduced the time required for baking and the associated clean-up tasks. For example, these coatings have made it significantly easier to use the bakeware (no more greasing the bake sheets; finished baked goods do not stick to the bake sheets) and to clean up after baking. However, because the non-stick coating is merely a coating, with regular use the surface develops scratches or can be worn or can flake off. When this occurs, consumers normally discard the baking item because it no longer functions as intended.

In recent years, the use of composite materials for normal household items has emerged. Composite materials are now routinely used for countertops, flooring and outdoor decking. The advantage of composite materials is that they have a consistent composition throughout the thickness of the item. Thus, any scratching or wearing of the surface is not obvious. Because the interior composition of a composite material is essentially identical to its surface composition many of the problems associated with non-stick coatings on bakeware could be avoided if the bakeware was made of a composite material. For example, scratches would not affect the performance of the bakeware and there would be no coating materiald to wear or flake away. The products made of composite materials would be expected to have significantly longer lifetimes than their non-composite material predecessors.

However, the composite materials of the prior art and the products made therefrom have some limitations. For example, the materials can be temperature sensitive and can be difficult to process into various shapes limiting the potential uses for these composite materials, thus limiting their utility for bakeware.

### SUMMARY OF THE PREFERRED EMBODIMENT

The present invention is bakeware having a non-stick surface comprising a composite material. The composite material is processed into shapes that are commonly used for bakeware. The bakeware produced from the composite material is stable at temperatures up to about 450° F., it is scratch resistant, when used for baking it delivers essentially the same level of browning as metal or ceramic materials, and it is recyclable.

### DETAILED DESCRIPTION OF THE PREFERRED EMBODIMENT

The present invention is bakeware comprising a composite material having a non-stick surface. The shaped composite material is stable to temperatures up to about 450° F. The composite material bakeware does not react with the pyrolysis by-products of food, oils and other baking materials so the bakeware does not demonstrate the brown discoloration stains that commonly occur with prior art bakeware. Further, because the bakeware is formed from a composite material, it is scratch resistant and recyclable.

The bakeware is formed from a thermally conductive but non-electrically conductive polymer that preferably includes ceramic filler particles. Suitable composite materials include Konduit® PDX-0-04415 and Konduit® PDX-0-04416 available from LNP Engineering Plastic Inc, 475 Creamery Way, Exton, Pa. 19341-2537. The Konduit® PDX-series of products are based on polyphenyl sulfide resins and proprietary filler materials. Other suitable thermoplastic resins that may be used for the bakeware include, without limitation, polysulfone, aromatic polyesters, polyamides, polyacetals, polyethersulfone, liquid crystal polymers, and combinations thereof. The Konduit® material is supplied in pellet form, although any form known in the art that can be used in injection molding processes may be used.

To form the bakeware, the composite material is injection molded into a predetermined shape. Typical shapes include those commonly used for baking, such as relatively flat sheets, cookie sheets with shallow edges, rectangular baking pans, round cake pans, round pie-shaped pans, pizza pans, deep-dish bakeware, muffin tins, or any other form that can accommodate baked goods. Alternative forms of molding, such as extrusion molding, may be used to form the bakeware, but with the Konduit® material, injection molding appears to be a more effective processing method.

Specific processing conditions may need to be adjusted depending on the type of item being produced and the particular composite selected for the bakeware. For example, without limitation, representative processing conditions for a Mold PIT+361 Machine 13010 Model G500 RS6 Resin EXCP0112 to prepare flat cookie sheets are:
(a) for injection phase: fill pressure limit of about 2500 psi, cooling time of up to about 40 seconds, shot size of up to about 135 mm, a fill time of about 1.25 seconds, a fill speed of less than about 0 mm/s, a fill pressure of less than about 10 psi, a maximum fill pressure of less than about 1830 psi, a cushion of less than about 10 mm, an injection position of less than about 150 mm and a cavity pressure of less than about 5 psi;
(b) for hold phase: cooling time of up to about 40 seconds, shot size of up to about 135 mm, a fill time of less than about 1.25 seconds, a fill speed of less than about 0 mm/s, a fill pressure of less than about 55 psi, a maximum fill pressure of less than about 1830 psi, a cushion of less than about 10 mm, an injection position of less than about 150 mm and a cavity pressure of less than about 5 psi;
(c) for recovery phase: shot size of up to about 135 mm, a screw speed of less than about 100 rpm, a recovery time of less than about 25 seconds, a fill pressure of less than about 75 psi, a maximum fill pressure of less than about 1830 psi, a cushion of less than about 10 mm, an injection position of less than about 150 mm and a cavity pressure of less than about 10 psi.

The resulting bakeware requires bake times and demonstrates browning similar to prior art non-stick coating bakeware when used to prepare chicken, cookies and muffins. The composite material has the further advantage that it can include color to be more aesthetically pleasing to the consumer. The inclusion of color to the composite material does not affect the processing to produce the bakeware.

It is understood that, in light of a reading of the foregoing description and drawings, those with ordinary skill in the art will be able to make changes and modifications to the present invention without departing from the spirit or scope of the invention, as defined herein. Further, it is understood that although the present invention is described with respect to forming bakeware, the injection molded composite material may be used in other applications where low-adhesion is desired, such as for skip boat hulls.

1. A bakeware item comprising a composite material molded into a predetermined shape, wherein the composite material comprises a thermoplastic resin selected from polyphenyl sulfide, polysulfone, aromatic polyesters, polyamides, polyacetals, polyethersulfone, liquid crystal polymers, and combinations thereof.

2. The bakeware of claim 1 wherein the thermoplastic resin comprises polyphenyl sulfide.

3. The bakeware of claim 1 wherein the item is molded by injection molding or extrusion molding.

4. The bakeware of claim 3 wherein the item is molded by injection molding.

5. The bakeware of claim 1 wherein the composite material is colored.

6. The bakeware of claim 1 wherein the predetermined shape is a flat sheet, a cookie sheet with shallow edges, a rectangular pan, a round cake pan, a round pie-shaped pan, a pizza pan, a deep-dish bakeware item, a muffin tin or any shape for preparing baked goods.

7. A bakeware item prepared by:
(a) providing a composite material comprising a thermoplastic resin selected from polyphenyl sulfide, polysulfone, aromatic polyesters, polyamides, polyacetals, polyethersulfone, liquid crystal polymers, and combinations thereof;
(b) molding the composition material into a predetermined form; and
(c) cooling the molded material.

8. The bakeware item of claim 7 wherein the composite material is provided in pellet form.

9. The bakeware item of claim 7 wherein the thermoplastic resin comprises polyphenyl sulfide.

10. The bakeware item of claim 7 wherein the molding is accomplished by injection molding or extrusion molding.

11. The bakeware item of claim 10 wherein the molding is accomplished by injection molding.

12. A bakeware item made from a composite material and having a shape defined as a flat sheet, a cookie sheet with shallow edges, a rectangular pan, a round cake pan, a round pie-shaped pan, a pizza pan, a deep-dish bakeware item, a muffin tin or any shape for preparing baked goods.

13. The bakeware item of claim 12 wherein the composite material comprises a thermoplastic resin selected from polyphenyl sulfide, polysulfone, aromatic polyesters, polyamides, polyacetals, polyethersulfone, liquid crystal polymers, and combinations thereof.

14. The bakeware item of claim 12 wherein the composite material comprises a thermoplastic resin selected from polyphenyl sulfide, polysulfone, aromatic polyesters, polyamides, polyacetals, polyethersulfone, liquid crystal polymers, and combinations thereof.

15. The bakeware item of claim 14 wherein the thermoplastic resin comprises polyphenyl sulfide.
